(19) United States
(12) Patent Application Publication
(10) Pub. No.: US 2009/0199566 A1
(43) Pub. Date: Aug. 13, 2009

(54) CO2 EMISSION-FREE ENERGY PRODUCTION BY GAS TURBINE

(76) Inventors: Etienne Lebas, Vienne (FR); Alexandre Rojey, Rueil-Malmaison (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/066,835

(22) PCT Filed: Sep. 15, 2006
(86) PCT No.: PCT/FR06/02134

§ 371 Date: Sep. 8, 2008

(30) Foreign Application Priority Data
Sep. 16, 2005 (FR) 0509525

(51) Int. Cl. F02C 3/04

(52) U.S. Cl. 60/772; 60/39.52

(57) ABSTRACT

The invention relates to a method for reducing the CO₂ rate present in the fumes discharged by a power generator burning a mixture of an oxidizer and of a fuel containing hydrocarbons, wherein the combustion fumes are expanded, a gas mixture comprising oxidizer and the fumes is compressed, at least part of the CO₂ present in a first part of the compressed mixture is removed and a second part of the compressed mixture is recycled so as to carry out combustion.

The invention also relates to a device for implementing the method.

### FIELD OF THE INVENTION

The present invention relates to the sphere of gas turbines, the carbon dioxide (CO2) released being captured under favourable concentration and pressure conditions.

Since the beginning of the industrial era, the rate of CO₂ present in the atmosphere increases regularly as a result of the growing increase in the use, as the energy source, of fuels referred to as “fossil” such as coal, liquid or gaseous hydrocarbons such as natural gas. It has been proved that the CO₂ released upon combustion of these fuels is responsible for the greenhouse effect and for the global warming of the planet that has been observed for some decades.

It is therefore essential, in order to limit the greenhouse effect in the years to come, to develop and to implement new CO₂ capture techniques prior to the final discharge of combustion fumes. These techniques have to be simple, robust, efficient and as little expensive as possible as regards their implementation and their operation.

In the sphere of thermal generators, a first solution consists in removing the CO₂ present in the combustion fumes before they are discharged into the atmosphere. The methods used are generally based on cryogenics, absorption by chemical or physical reaction with another compound, or membrane separation. The large amounts of fumes to be treated and the low CO₂ partial pressures in these fumes at atmospheric pressure explain why these solutions are however complex and costly to implement.

### BACKGROUND OF THE INVENTION

Document FR-2,825,935 describes a gas turbine layout with great advantages in relation to the prior art. This layout illustrated by FIG. 1 allows to capture the CO₂ under pressure and at a higher concentration than that normally obtained at the outlet of a gas turbine. It however involves the drawback of requiring a gas purge in order to prevent nitrogen and oxygen accumulation. Part of the CO₂ generated is thus discharged into the atmosphere.

The present invention aims to provide CO₂ capture on relatively concentrated gases under pressure while avoiding discharging a CO₂-containing stream.

### SUMMARY OF THE INVENTION

In general terms, the present invention relates to a method for reducing the CO₂ rate present in the fumes discharged by a power generator burning a mixture of an oxidizer and of a fuel containing hydrocarbons, wherein the following stages are carried out:

a) expanding the combustion fumes,

b) compressing a gas consisting at least partly of the combustion fumes,

c) removing at least part of the CO₂ present in a first part of the compressed gas obtained in stage b),

d) recycling a second part of the compressed gas obtained in stage b), the oxidizer comprising at least the second part of the compressed gas.

According to the invention, prior to stage b), the combustion fumes can be mixed with a gas comprising oxygen so that the gas compressed in stage b) comprises combustion fumes and oxygen. Alternatively, prior to stage d), said second part of the compressed gas can be mixed with a gas comprising oxygen.

The compressed gas obtained in stage b) can be cooled and, prior to stage d), the second part of the compressed gas can be compressed.

The CO₂-depleted gases obtained in stage c) can be expanded, then discharged into the atmosphere.

The combustion fumes can be cooled by heat exchange with an absorbent solution used in stage c).

The power generator can perform a catalytic combustion.

The oxygen content can be adjusted in such a way that combustion is carried out under stoichiometric conditions. The gas comprising oxygen can be air.

The present invention also relates to a power generator burning a mixture of an oxidizer and of a fuel containing hydrocarbons, the generator comprising a compressor, combustion means, an expansion turbine and means for separating the CO₂ contained in a gas stream, the compressor outlet being connected, on the one hand, to an inlet of the combustion means and, on the other hand, to the inlet of the CO₂ separation means.

According to the invention, the combustion means can comprise catalytic burners. The CO₂ separation means can be selected from the group made up of the columns using absorption solvents, cryogenic distillation columns, membranes, adsorbent molecular sieves.

### BRIEF DESCRIPTION OF THE FIGURES

Other features and advantages of the invention will be clear from reading the description hereafter, with reference to FIGS. 1 to 5 wherein similar elements are designated by identical reference numbers, and wherein:

FIG. 1 illustrates according to the prior art the layout of an electric generator including a gas turbine and a device for capturing the CO₂ on the gas recycled after compression of this gas,

FIG. 2 diagrammatically shows a power generator according to the invention,

FIG. 3 shows an example of a method for capturing the CO₂,

FIGS. 4 and 5 show variants of the power generator according to the invention.

### DETAILED DESCRIPTION

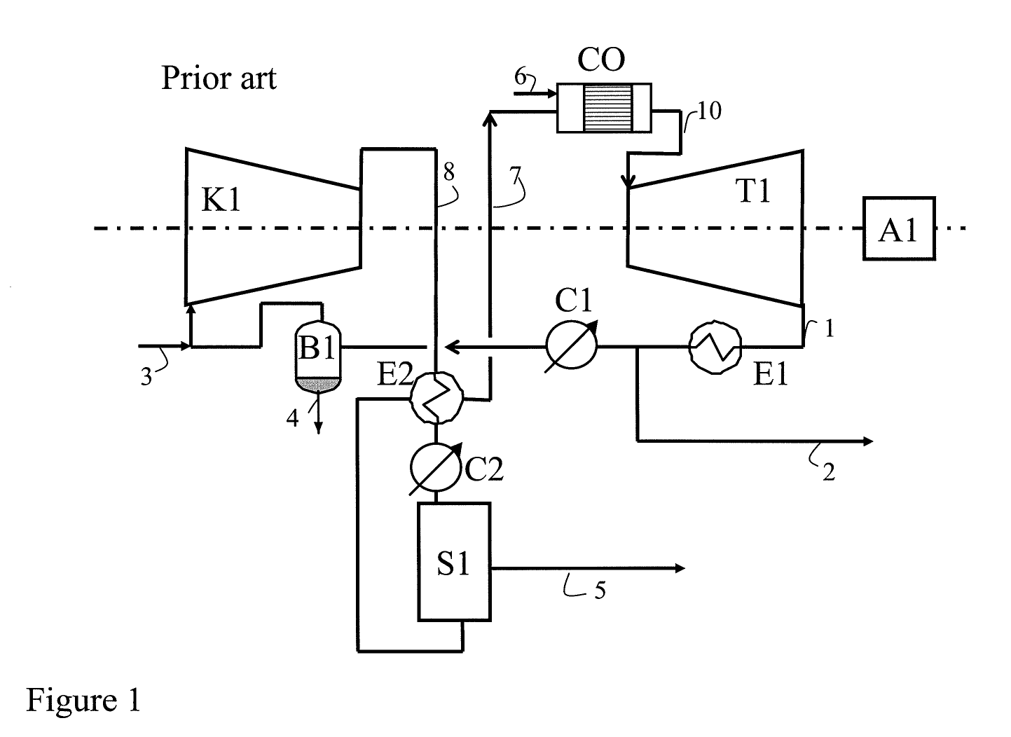

FIG. 1 diagrammatically shows an energy generator according to the prior art, of gas turbine type, in which a liquid or gaseous hydrocarbon-containing fuel (natural gas in the examples given hereafter) is burnt, followed by a CO₂ separation device S1.

The power generator consists of a gas turbine including:

a compressor K1 comprising at least one compression stage,

a combustion chamber CO,

an expansion turbine T1 supplying the energy required for driving compressor K1 and alternator A1.

The supply air flowing in through line 3 is mixed with recycled combustion gases so as to be able to increase the CO₂ content of the gases circulating in the compression section of the device.

The gases compressed by K1 are diverted through line 8 in order to extract the CO₂ by means of separation device S1. The CO₂ that is recovered through line 5 can be stored for example in the subsoil. CO₂ capture is carried out on relatively concentrated gases under pressure, which is advantageous. It is however necessary to purge part of the gas flowing from the turbine through line 2 to discharge the nitrogen flowing in with the combustion air. CO₂ is thus released. CO₂ recovery therefore remains limited.

The present invention aims to provide CO₂ capture on relatively concentrated gases under pressure while avoiding discharging a stream comprising CO₂. According to the invention, this is performed so as to be able to simultaneously discharge the CO₂ produced by combustion and the nitrogen introduced with the combustion air, without releasing CO₂ with the nitrogen that is discharged.

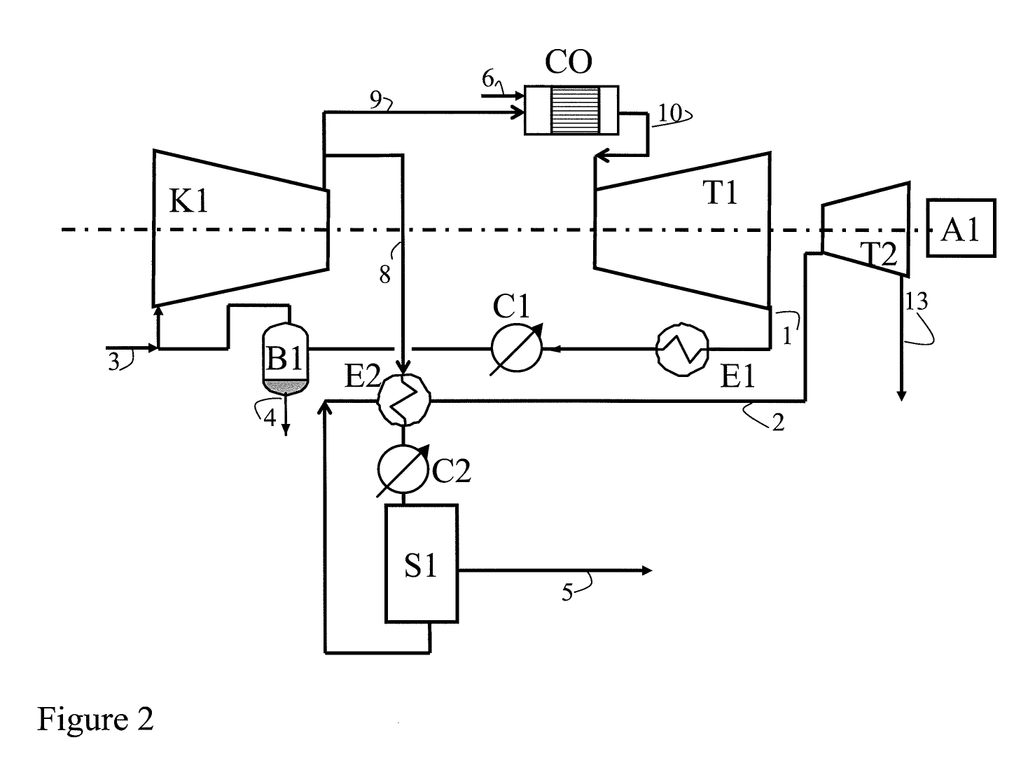

The principle of the invention is described in connection with the diagram of FIG. 2. In this configuration example, the combustion fumes mixed with air flowing in through line 3 are compressed by compressor K1.

A first fraction of the compressed gas is diverted through line 8. This gas fraction is first cooled in gas-gas heat exchanger E2 with a gas fraction discharged from S1, then by means of an outer coolant in heat exchanger C2. The cooled compressed gas is fed into separation device S1 wherein the CO₂ is separated from the nitrogen. The CO₂ is discharged from device S1 through line 5 and it is for example recompressed and injected into the subsoil to be stored. A substantially CO₂-free and nitrogen-rich gas that also contains a small proportion of oxygen is obtained after this separation. This gas is passed into exchanger E2 where it is heated, then it is expanded in turbine section T2. The expanded gas that is discharged through line 13 contains nitrogen, a small proportion of oxygen but practically no more CO₂.

A second fraction of the compressed gas from K1 is sent through line 9 into combustion chamber CO as the oxidizer. The fuel, liquid or gaseous hydrocarbons for example, is fed into CO through line 6. The combustion fumes discharged from CO through line 10 are expanded in turbine T1, cooled by heat exchange in E1 and C1, then recycled to the inlet of compressor K1. The water condensed by cooling in E1 and C1 can be separated from the fumes in drum B1, and discharged through line 4.

Any known method can be used to separate the CO₂ in device S1. For example, a CO₂ absorption method using a physical or a chemical solvent, as notably described in documents EP-744,987 and WO-00/57,990, can be used. The absorbent solution can comprise for example primary amines such as MEA, DGA and DIPA, secondary amines such as DEA, tertiary amines such as MDEA. A potassium carbonate solution can also be used. Furthermore, device S1 can implement a cryogenic distillation method, a membrane separation method and more particularly a separation method using a gas permeation membrane, or it can be based on the use of adsorption techniques on molecular sieves. These methods are for example described in “Natural gas: production, processing, transport” (A. Rojey and C. Jaffret), Editions Technip, Paris, 1997.

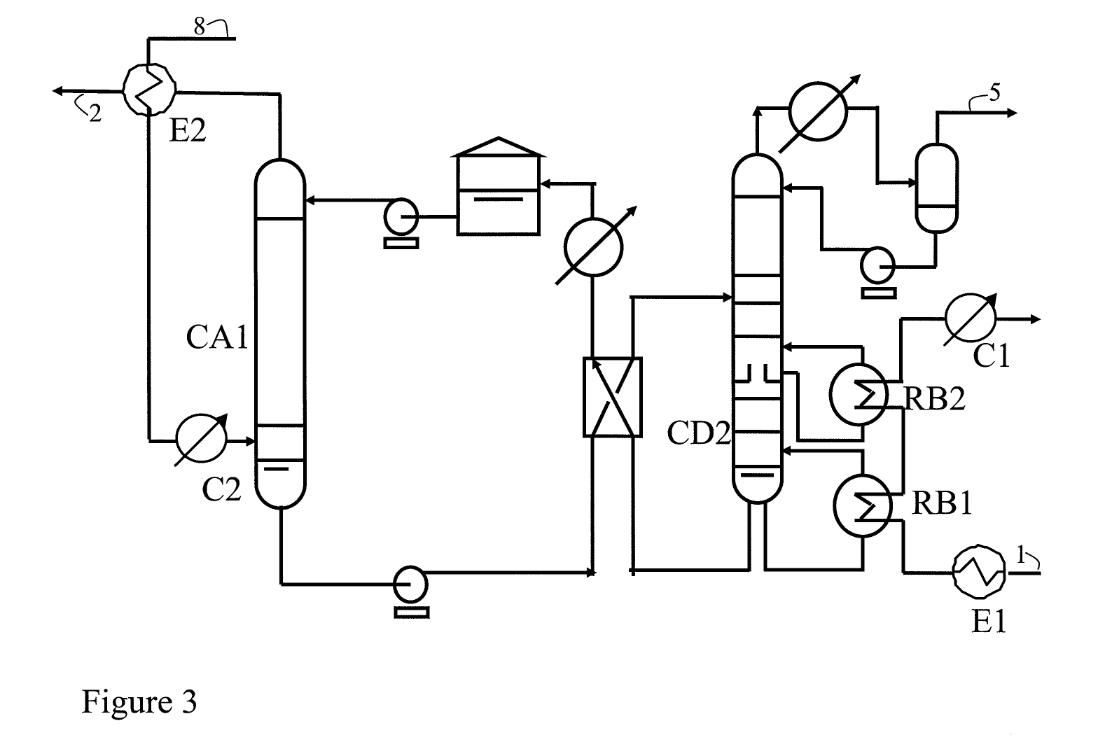

FIG. 3 implements in device S1 a CO₂ absorption method using a solvent. The method described in connection with FIG. 3 is integrated in the method described by FIG. 2, identical reference numbers designating the same elements. In FIG. 3, the compressed gas flowing in through line 8 is cooled by heat exchangers E2 and C2, then fed into absorption column CA1 to be contacted with a solvent comprising an amine that absorbs the CO₂. The solvent is regenerated in distillation column CD2. In the configuration example that is shown in FIG. 3, distillation column CD2 operates on the one hand with a reboiler RB1 located in the bottom of the distillation column and with an intermediate reboiler RB2 located at an intermediate level between the bottom and the top of the column. The expanded and recycled gas fraction has to be cooled. It is advantageous in this case to recover at least partly the available heat in order to regenerate the solvent used for capturing the CO₂.

The two reboilers RB1 and RB2 allow to recover the heat within a wide temperature range. Thus, the gas leaving turbine T1 through line 1 is first cooled in heat exchanger E1, wherein it produces vapour that can supply a condensation cycle producing additional electric power. It is then fed into reboilers RB1 and RB2 where it provides the heat required for regeneration of the solvent in distillation column CD2. The gas is then sent to final cooling exchanger C1. It is also possible to use an auxiliary heat carrier allowing to recover the heat on the exhaust gases of turbine section T1 and to heat reboilers RB1 and RB2.

The presence of oxygen in the gas fed into device S1 can be inconvenient in some cases. In fact, when S1 implements a CO₂ absorption method using a solvent, the presence of oxygen can affect the chemical stability of the solvent. Besides, the loss of oxygen requires a supply air flow rate increase, which is not favourable to the overall efficiency of the device.

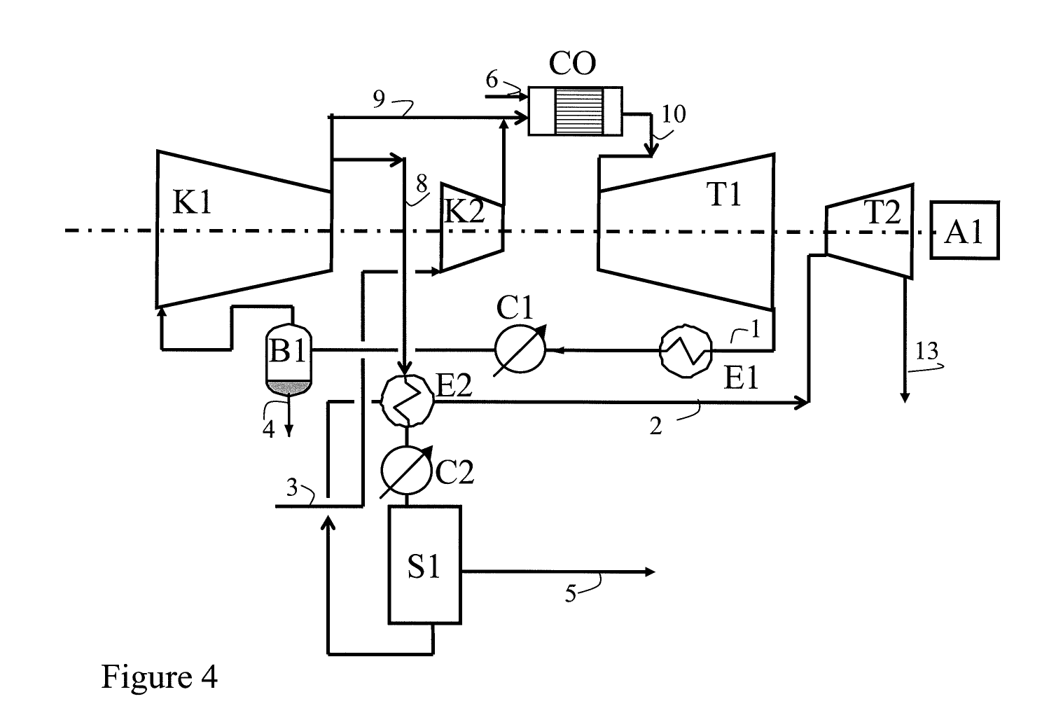

This presence of oxygen in the gas treated by device S1 can be avoided using the layout shown in FIG. 4.

The fumes flowing in through line 1 are compressed in compression zone K1. The air coming in through line 3 is compressed in a compression zone K2 distinct from compression zone K1. For example, K1 and K2 can be two distinct compressors. K1 and K2 can also be two distinct compression stages and mounted on a single drive shaft. The air compressed in K2 is mixed with the gas fraction discharged from K1 through line 9. This mixture of gas under pressure is fed into combustion chamber CO. Under such conditions, the gas fraction discharged through line 8 contains nitrogen and CO₂, but practically no oxygen, which allows practically pure nitrogen to be discharged through line 13.

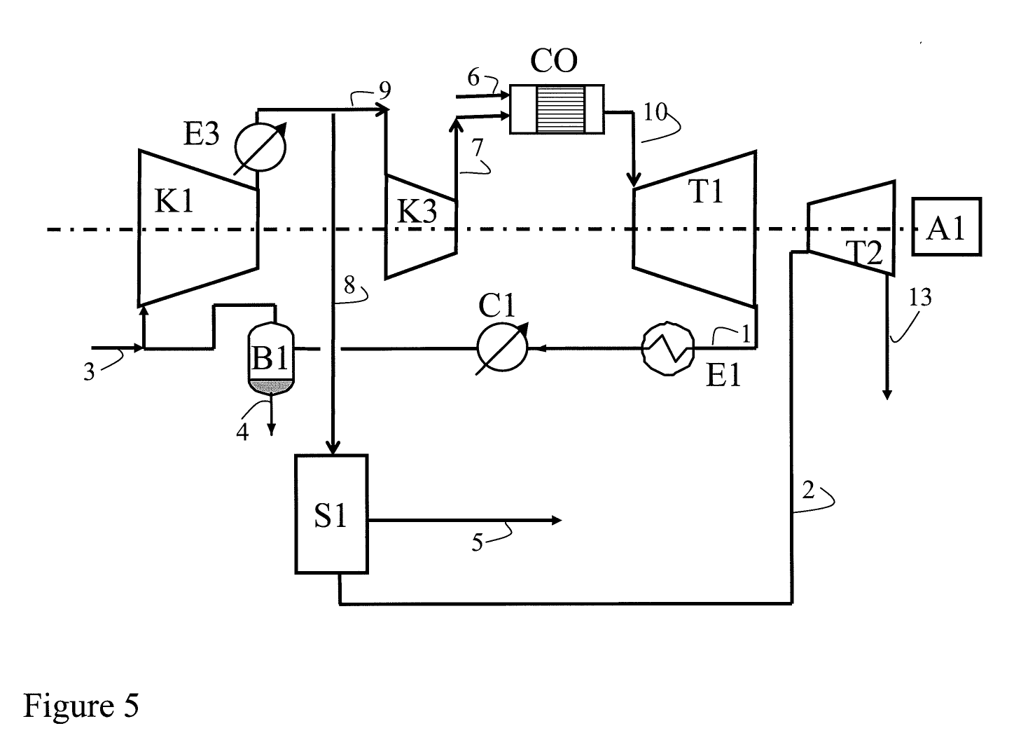

FIG. 5 shows a variant of the method diagrammatically shown in FIG. 2. In FIG. 5, the mixture of air and of fumes compressed by compressor K1 is cooled in heat exchanger E3, then it is separated into two gas fractions discharged through lines 8 and 9. The gas fraction circulating in line 8 is freed from the CO₂ in device S1, then expanded in turbine T2. The CO₂-depleted gas is expanded in turbine T2. The gas fraction circulating in line 9 is compressed in compression zone K3, then fed through line 7 into combustion chamber CO.

The variant shown in FIG. 5 corresponds to a gas turbine comprising an intermediate cooling stage, commonly referred to as inter-cooling, on the compressor. Exchanger E3 allows on the one hand to cool the gases intended to be compressed by K3 and, on the other hand, to cool the gases sent to device S1. Thus, CO₂ capture requires no additional heat exchangers.

Alternatively, instead of mixing the air with the fumes prior to compression in K1, the air can be compressed by a compressor distinct from compressor K1, then mixed with the gas fraction circulating in line 9 or 7, fed into combustion chamber CO as the oxidizer.

The advantages of the present invention are illustrated by the following numerical examples.

### EXAMPLE 1 (ACCORDING TO THE PRIOR ART)

A device similar to the device described in connection with FIG. 1 is used in this example. According to the simulation carried out by the applicant, the air flows in through line 3 at a flow rate of 21,966 kmol/h (kilomoles per hour). The fuel consists of natural gas fed into chamber CO through line 6 at a flow rate of 2306 kmol/h. The total amount of air introduced is mixed upstream from the compressor with recycled cold fumes from drum B1 whose flow rate is 26,600 kmol/h (corresponding to a recycle rate of about 60% of the fumes).

The mixture is compressed to 30 bars by compressor K1. The gas under pressure is cooled to 50° C., then it is sent to absorption means S1 which is a column wherein a countercurrent liquid circulation of amine and of the compressed gas is performed. The column is dimensioned in such a way that 90% of the CO₂ contained in the mixture is absorbed. The mixture freed of the major part of the CO₂ it contained is then sent via line 7 to combustion chamber CO equipped with catalytic burners.

The fumes whose temperature is about 1300° C. are fed to the inlet of expansion turbine T1. At the expansion turbine outlet, the molar flow rate of the treated fumes is 48,470 kmol/h, about 60% of which is recycled to compressor K1. The flow rate of the carbon dioxide discharged through line 2 is in this case about 1026 kmol/h. The CO₂ capture rate in this unit is thus 44.5%.

### EXAMPLE 2 (ACCORDING TO THE INVENTION)

A device similar to the device described in connection with FIG. 2 is used in this example. According to the simulation carried out by the applicant, the air flows in through line 3 at a flow rate of 43,920 kmol/h (kilomoles per hour). The fuel consists of natural gas fed into chamber CO through line 6 at a flow rate of 2306 kmol/h. The total amount of air introduced is mixed upstream from the compressor with recycled cold fumes from drum B1 whose flow rate is 41,038 kmol/h (corresponding to a recycle rate of 100% of the fumes).

The mixture is compressed to 30 bars by compressor K1. Part of this mixture is sent via line 9 to combustion chamber CO. The fumes whose temperature is about 1300° C. are fed to the inlet of expansion turbine T1. The other part of the compressed mixture is discharged through line 8. This gas under pressure is cooled to 50° C. in exchangers E2 and C2, then it is sent to absorption means S1, which is a column wherein a countercurrent liquid circulation of amine and of compressed gas is carried out. The column is dimensioned in such a way that 90% of the CO₂ contained in the mixture is absorbed by the amine stream. The mixture freed of the major part of the CO₂ it contained is then sent via line 2 into expansion turbine T2.

The flow rate of the carbon dioxide discharged through line 13 is in this case about 230 kmol/h. The CO₂ capture rate in this unit is thus 90%.

### EXAMPLE 3 (ACCORDING TO THE INVENTION)

A device similar to the device described in connection with FIG. 4 is used in this example. According to the simulation carried out by the applicant, the air flows in through line 3 at a flow rate of 21,966 kmol/h. It is compressed to 30 bars by compressor K2. The fuel consists of natural gas fed into chamber CO through line 6 at a flow rate of 2306 kmol/h. The air is then mixed upstream from combustion chamber CO with part of the recycled fumes from compressor K1 whose flow rate is 47,816 kmol/h.

The fumes whose temperature is about 1300° C. are fed to the inlet of expansion turbine T1, then recycled to compressor K1.

Part of the mixture is discharged through line 8. This gas under pressure is cooled to 50° C. in exchangers E2 and C2, then it is sent to absorption means S1, which is a column wherein a countercurrent liquid circulation of amine and of compressed gas is carried out. The column is dimensioned in such a way that 90% of the CO₂ contained in the mixture is absorbed. The mixture freed of the major part of the CO₂ it contained is then sent via line 2 into expansion turbine T2.

The flow rate of the carbon dioxide discharged through line 13 is in this case about 230 kmol/h. The CO₂ capture rate in this unit is thus 90%.

1) A method for reducing the CO₂ rate present in the fumes discharged by a power generator burning a mixture of an oxidizer and of a fuel containing hydrocarbons, wherein the following stages are carried out:
a) expanding the combustion fumes,
b) compressing a gas consisting at least partly of the combustion fumes,
c) removing at least part of the CO₂ present in a first part of the compressed gas obtained in stage b),
d) recycling a second part of the compressed gas obtained in stage b), the oxidizer comprising at least the second part of the compressed gas.

2) A method as claimed in claim 1 wherein, prior to stage b), the combustion fumes are mixed with a gas comprising oxygen so that the gas compressed in stage b) comprises combustion fumes and oxygen.

3) A method as claimed in claim 1 wherein, prior to stage d), said second part of the compressed gas is mixed with a gas comprising oxygen.

4) A method as claimed in claim 2, wherein said gas comprising oxygen is air.

5) A method as claimed in claim 2, wherein the oxygen content is adjusted in such a way that combustion is carried out under stoichiometric conditions.

6) A method as claimed in claim 1, wherein the compressed gas obtained in stage b) is cooled and wherein, prior to stage d), the second part of the compressed gas is compressed.

7) A method as claimed in claim 1, wherein the CO₂-depleted gases obtained in stage c) are expanded, then discharged into the atmosphere.

8) A method as claimed in claim 1, wherein the combustion fumes are cooled by heat exchange with an absorbent solution used in stage c).

9) A method as claimed in claim 1, wherein the power generator performs a catalytic combustion.

10) A power generator burning a mixture of an oxidizer and of a fuel containing hydrocarbons, the generator comprising a compressor (K1), combustion means (CO), an expansion turbine (T1) and means (S1) for separating the CO₂ contained in a gas stream, the outlet of compressor (K1) being connected, on the one hand, to an inlet of combustion means (CO) and, on the other hand, to the inlet of CO₂ separation means (S1).

11) A generator as claimed in claim 10, wherein combustion means (CO) comprise catalytic burners.

12) A generator as claimed in claim 10, wherein CO₂ separation means (S1) are selected from the group made up of the columns using absorption solvents, cryogenic distillation columns, membranes, adsorbent molecular sieves.
